(19) United States
(12) Patent Application Publication
(10) Pub. No.: US 2012/0267144 A1
(43) Pub. Date: Oct. 25, 2012

(54) Plenum Data Cable

(76) Inventors: Bernhart Allen Gebs, Powder Spring, GA (US); Timothy William Waldner, Marietta, GA (US)

(21) Appl. No.: 13/432,442

(22) Filed: Mar. 28, 2012

Related U.S. Application Data
(60) Provisional application No. 61/477,917, filed on Apr. 21, 2011.

(51) Int. Cl. H01B 11/02

(52) U.S. Cl. 174/113 R

(57) ABSTRACT

A communication cable can comprise twisted pairs of electrical conductors for transmitting electrical signals, such as for digital communication or data transmission. One or more electrical conductors of the cable can be insulated with a premium polymeric material that provides relatively high levels of electrical performance and fire performance. For example, one or more of the electrical conductors could be insulated with fluorinated ethylene propylene. One or more other electrical conductors of the cable can be insulated with other, economical polymeric materials in a configuration meeting electrical and fire performance objectives. For example, one or more of the electrical conductors could be insulated with foamed polyolefin, such as foamed polyethylene, covered by a polyvinyl chloride skin that functions as a fire barrier.

### CROSS REFERENCE TO RELATED APPLICATIONS

This patent application claims priority under 35 U.S.C. §119 to U.S. Provisional Patent Application No. 61/477,917, entitled “Plenum Data Cable with PE Insulation and LSPVC (Low Smoke Polyvinyl Chloride) Skin” and filed Apr. 21, 2011 in the name of Bernhart Allen Gebs and Timothy William Waldner, the entire contents of which are hereby incorporated herein by reference.

### FIELD OF THE TECHNOLOGY

The present invention relates to communication cables comprising multiple twisted pairs of electrical conductors for transmitting communication signals, and more specifically to cables in which the electrical conductors have insulation systems that utilize economical insulation materials and/or multiple insulation configurations.

### BACKGROUND

The escalating drive for enhanced communication bandwidth presses transmission media to convey information faster and more efficiently while maintaining signal fidelity and avoiding crosstalk. The market further expects cost reduction to accompany advances in performance.

A single communication cable may be called upon to transmit multiple communication signals over respective electrical conductors concurrently. Additionally, the cable may be deployed in an application involving fire performance considerations, such as in certain plenum applications where low smoke and flame generation is typically desired.

Such a communication cable may have two or more twisted pairs of insulated electrical conductors (“twisted pairs”). The material of the twisted pair insulation affects not only interference associated with signal energy coupling between or among the pairs, but also signal loading and fire performance. Conventional materials offering improved electrical and fire performance typically impose higher costs. Accordingly, cable designers face challenges with achieving high electrical and flame performance objectives on the one hand and with meeting economic constraints on the other hand.

For example, fluorinated ethylene propylene (“FEP”) offers desirable levels of electrical and fire performance, but is typically expensive and can be subject to supply shortages. Polyethylene (“PE”) generally supports desirable electrical performance and is economical, but typically has reduced fire performance. Polyvinyl chloride (“PVC”) generally supports desirable fire performance and is economical, but typically has reduced electrical performance. For example, low smoke polyvinyl chloride (“LSPVC”) can have a high dielectric constant, such as approximately 3.5, that with conventional insulation configurations can be incompatible with high frequency data transmission, resulting in impaired quality of transmitted signals.

Fluoropolymers, such as fluorinated ethylene propylene, can be used as insulation material for high performance copper data cables that are specifically designed for plenum flame/smoke ratings. The desirable electrical characteristics of fluoropolymers generally provide low dielectric and dissipation properties, and most fluoropolymers further exhibit good flame/smoke properties when subjected to industry standard flame tests. Fluoropolymers, however, are often prohibitively expensive and are frequently in short supply.

Accordingly, need is apparent for technology to impart a cable with suitable electrical and fire performance while achieving economic and material supply objectives. Need further exists to reduce fluoropolymer utilization in plenum data cables. A capability addressing such need, or some related deficiency in the art, would support cost effective communications and elevate bandwidth that a communication cable can carry cost effectively.

### SUMMARY

A communication cable can comprise multiple electrical conductors for transmitting multiple communication signals concurrently. The communication signals can comprise digital or discrete signal levels supporting digital communication, for example. The communication cable can comprise twisted pairs of insulated electrical conductors that extend lengthwise along the cable.

Some (or all) of the electrical conductors can be insulated with a combination of economical materials that achieves electrical performance objectives while supporting acceptable fire performance of the cable. Other electrical conductors can be insulated with premium material offering high fire performance and high electrical performance.

For example, one or more electrical conductors can be covered with an economical two-part insulation. The two-part insulation can comprise an inner layer of economical polymer skinned with another economical polymer. The inner economical polymer can offer high electrical performance but relatively relaxed fire performance. The economical polymer skin can offer higher fire performance and function as a fire barrier. The economical polymer skin can function adequately electrically even with the material of the skin having relaxed electrical properties since the skin can be relatively thin and/or since the inner polymer can provide physical separation between the skin and the electrical conductor.

The foregoing discussion of materials and configurations for twisted pair cables is for illustrative purposes only. Various aspects of the present invention may be more clearly understood and appreciated from a review of the following detailed description of the disclosed embodiments and by reference to the drawings and the claims that follow. Moreover, other aspects, systems, methods, features, advantages, and objects of the present invention will become apparent to one with skill in the art upon examination of the following drawings and detailed description. It is intended that all such aspects, systems, methods, features, advantages, and objects are to be included within this description, are to be within the scope of the present invention, and are to be protected by the accompanying claims.

### BRIEF DESCRIPTION OF THE DRAWINGS

FIG. 1 is a cross sectional view of an exemplary communication cable that comprises four twisted pairs of electrical conductors, at least some of which having insulation that is economical in accordance with certain embodiments of the present invention.

FIG. 2 is an illustration of an exemplary twisted pair of a communication cable in accordance with certain embodiments of the present invention.

FIG. 3 is an illustration depicting exemplary twists of a communication cable in accordance with certain embodiments of the present invention.

FIG. 4 is an illustration depicting exemplary insulation covering an electrical conductor of a twisted pair in accordance with certain embodiments of the present invention.

Many aspects of the invention can be better understood with reference to the above drawings. The elements and features shown in the drawings are not to scale, emphasis instead being placed upon clearly illustrating the principles of exemplary embodiments of the present invention. Moreover, certain dimensions may be exaggerated to help visually convey such principles. In the drawings, reference numerals designate like or corresponding, but not necessarily identical, elements throughout the several views.

### DETAILED DESCRIPTION OF EXEMPLARY EMBODIMENTS

A communication cable can incorporate a combination of economical polymers to abate reliance on premium polymers. In certain embodiments, the communication cable can be a twisted pair communication cable. In certain embodiments, the communication cable can be a plenum data cable. In certain embodiments, the communication cable can be a twisted pair communication cable rated for plenum applications. In certain embodiments, the communication cable can be qualified for plenum applications. In certain embodiments, the communication cable can be qualified for deployment in air-handling spaces.

One or more electrical conductors within the communication cable can be insulated with an economical two-part insulation. An inner region or layer of the two-part insulation can comprise an economical polymer offering desirable electrical properties but relaxed fire properties. An exterior region or layer of the two-part insulation can comprise another economical polymer offering desirable fire properties but relaxed electrical properties. The resulting two-part insulation can achieve fire and electrical performance objectives while meeting financial considerations.

In certain embodiments, the communication cable can comprise polyethylene material and an associated low smoke polyvinyl chloride skin that form electrical insulation. In certain embodiments, insulating one or more twisted pairs with polyethylene covered by a polyvinyl chloride skin, for example a low smoke polyvinyl chloride skin, reduces the amount of fluoropolymer incorporated in the communication cable, in certain cases eliminating fluoropolymer altogether. In certain embodiments, the skin has a thickness in a range between approximately 0.001 inches and 0.003 inches. The term “skin,” as used herein, generally refers to an outer layer, film, casing, or coating. A skin is not necessarily the outermost layer, film, casing, or coating; for example, a colorant or film could be applied over a skin.

The skin can improve the flame performance of the cable when burned, as compared to unskinned polyethylene insulation. The skin can reduce burn distance under a flame test specified by a government or industry standard, regulation, or code. For example, the skin can improve performance under the test published by the National Fire Protection Association that is known as “NFPA 262: Standard Method of Test for Flame Travel and Smoke of Wires and Cables for Use in Air-Handling Spaces,” the 2011 edition of which is hereby incorporated herein by reference.

In certain embodiments, the communication cable can comprise four twisted pairs. One, two, three, or four of the twisted pairs can comprise two electrical conductors, for example wires of copper or other appropriate metal, insulated with economical polymeric materials. Polyethylene insulation can be disposed circumferentially around at least one conductor of one, two, three, or four of the twisted pairs, with a skin of low smoke polyvinyl chloride applied over the polyethylene. In certain embodiments, the polyethylene may be either solid or foamed. In certain embodiments, the polyethylene can comprise linear low density polyethylene, linear high density polyethylene, or polyethylene in a density range between high and low. The skin thickness and the conductor, pair, and insulation diameters can be selected according to testing and/or configuration specifics, dielectric constant and dissipation factors of the materials, and interrelationships among materials in the communication cable. The result can achieve impedance, insertion loss, and other cable electrical specifications.

In certain embodiments, the communication cable can comprise at least one twisted pair in which one or both electrical conductors are insulated with fluorinated ethylene propylene or another appropriate fluoropolymer. In certain embodiments, the fluoropolymer can be foamed. In certain embodiments, the fluoropolymer can be solid (i.e. substantially unfoamed). In certain embodiments, the communication cable can achieve tight cost constraints by utilizing economical polymeric materials where feasible and incorporating premium polymeric materials strategically to offset performance issues otherwise associated with economical materials utilization.

In certain embodiments, the communication cable can comprise an exterior cover or jacket comprising polyvinyl chloride, such as low smoke polyvinyl chloride. The jacket and the low smoke polyvinyl chloride skin can collaboratively control flame spread and smoke released during NFPA 262 flame testing.

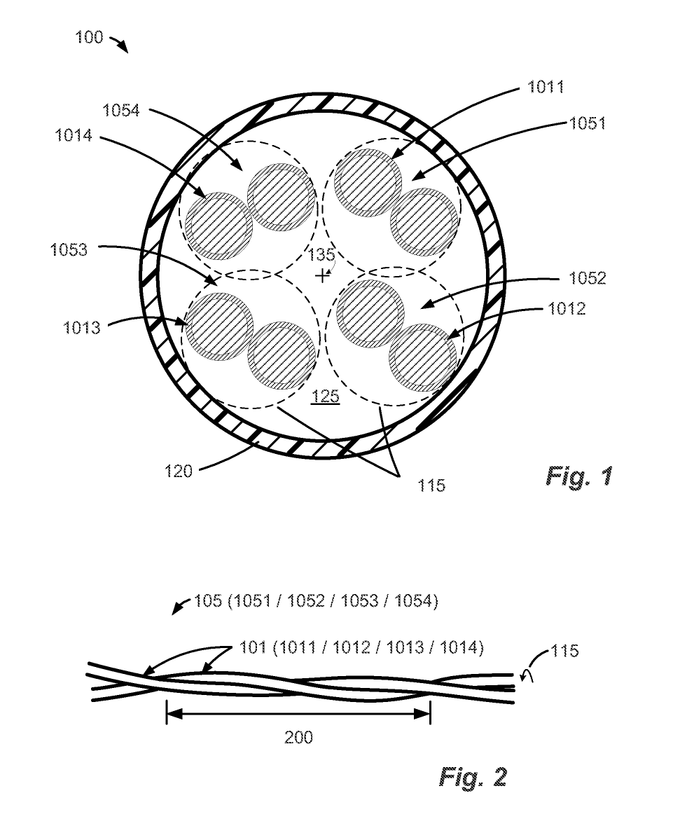

Technology for cost effective management of electrical performance in a communication cable will now be described more fully with reference to FIGS. 1-4, which illustrate representative embodiments of the present invention. FIGS. 1, 2, 3, and 4 describe exemplary features of a communication cable comprising twisted pairs incorporating economical insulation materials.

The invention can be embodied in many different forms and should not be construed as limited to the embodiments set forth herein; rather, these embodiments are provided so that this disclosure will be thorough and complete, and will fully convey the scope of the invention to those having ordinary skill in the art. Furthermore, all “examples” or “exemplary embodiments” given herein are intended to be non-limiting and among others supported by representations of the present invention.

Turning now to FIG. 1, this figure illustrates a cross sectional view of a communication cable 100 that comprises four twisted pairs 105 (1051, 1052, 1053, 1054) of electrical conductors, at least some of which having insulation 101 (1011, 1012, 1013, 1014) that is economical according to certain exemplary embodiments of the present invention. In certain embodiments, the illustrated communication cable 100 can be deployed in plenum applications and/or be designated as a plenum cable.

As discussed in further detail below, the insulation 101 (1011, 1012, 1013, 1014) can comprise an interior region formed of a economical polymeric material and skinned with a different economical polymeric material. The inner polymeric material can have better electrical properties as compared to the polymeric material of the outer skin. The outer polymeric material can have better fire properties as compared to the inner polymeric material. In collaboration, the two polymeric materials can economically impart the communication cable 100 with desired fire and electrical properties.

A jacket 120 typically having a polymer-based composition seals the communication cable 100 from the environment and provides strength and structural support. In one exemplary embodiment, the jacket 120 has an outer diameter of about 0.192 inches and an inner diameter of about 0.152 inches, with such dimensions being but one representative example provided without limitation. As discussed above, the jacket 120 can comprise polyvinyl chloride that is low smoke and/or flame retardant.

In various embodiments, the jacket 120 can comprise one or more polymeric materials, for example polyvinyl chloride, low smoke polyvinyl chloride, flame retardant polyvinyl chloride, low temperature oil resistant polyvinyl chloride, flexible polyvinyl chloride, polyurethane, fluoropolymer, polyethylene, neoprene, cholorosulphonated polyethylene, fluorinated ethylene propylene, polyolefin, flame retardant polyurethane, or some other appropriate material known in the art, or a combination thereof, for example. In certain exemplary embodiments, the jacket 120 can comprise flame retardant and/or smoke suppressant materials.

The jacket 120, which extends lengthwise along the communication cable 100, can be single layer or have multiple layers. In certain exemplary embodiments, a tube or tape (not illustrated) can be disposed between the jacket 120 and the twisted pairs 105. Such a tube or tape can be made of polymeric or dielectric material, for example. In various embodiments, the jacket 120 can be characterized as an outer jacket, an outer sheath, a casing, a circumferential cover, or a shell.

The communication cable 100 can comprise shielding or may be unshielded, as FIG. 1 illustrates. In certain exemplary embodiments, a metallic foil or other electrically conductive material can cover the twisted pairs 105 individually or collectively and/or the cable core 125 to provide shielding. In certain exemplary embodiments, the communication cable 100 can be shielded with a system of electrically isolated patches of shielding material, for example as described in U.S. Pat. No. 7,923,641 (U.S. patent application Ser. No. 12/313,914), entitled “Communication Cable Comprising Electrically Isolated Patches of Shielding Material.” The entire contents of U.S. patent application Ser. No. 12/313,914 and U.S. Pat. No. 7,923,641, entitled “Communication Cable Comprising Electrically Isolated Patches of Shielding Material” are hereby incorporated herein by reference.

A metallic material, whether continuous or comprising electrically conductive patches, can be disposed on a substrate, such as a tape placed between the twisted pairs 105 and the jacket 120, or adhered to the jacket 120. For example, shielding, whether continuous or electrically isolated, can be disposed or sandwiched between the jacket 120 and a tube or tape that is disposed between the jacket 120 and the twisted pairs 105. In certain embodiments, the jacket 120 comprises conductive material and may be or function as a shield. In certain embodiments, the jacket 120 comprises armor, or the communication cable 100 comprises a separate, outer armor for providing mechanical protection.

In the illustrated embodiment, the cable core 125 of the communication cable 100 contains four twisted pairs 105, four being an exemplary, rather than limiting, number. Other exemplary embodiments may have fewer or more twisted pairs 105. The twisted pairs 105 extend along the longitudinal axis 135 of the communication cable 100 within the cable core 125.

Each twisted pair 1051, 1052, 1053, 1054 can carry data or some other form of information, for example in a range of about one to ten Giga bits per second (“Gbps”) or at another appropriate speed, whether faster or slower. In certain exemplary embodiments, each twisted pair 1051, 1052, 1053, 1054 supports data transmission of about two and one-half (2.5) Gbps (e.g. nominally two and one-half Gbps), with the communication cable 100 supporting about ten Gbps (e.g. nominally ten Gbps). In certain exemplary embodiments, each twisted pair 1051, 1052, 1053, 1054 supports data transmission of about ten Gbps (e.g. nominally ten Gbps), with the communication cable 100 supporting about forty Gbps (e.g. nominally forty Gbps). In certain exemplary embodiments, the communication cable 100 carries about twelve and one-half Gbps.

The illustrated communication cable 100 can convey four distinct channels of information simultaneously, one channel per twisted pair 1051, 1052, 1053, 1054. In certain exemplary embodiments, the metallic conductor diameter of each twisted pair 1051, 1052, 1053, 1054 can be in a range of about 0.0223 inches to about 0.0227 inches. In certain exemplary embodiments, the metallic conductor diameter of each twisted pair 1051, 1052, 1053, 1054 can be in a range of about 0.0195 inches to about 0.0199 inches.

In certain exemplary embodiments, the outer, insulation diameter covering each metallic conductor can be in a range of about 0.0385 inches to about 0.0395 inches, for example. In certain exemplary embodiments, the outer, insulation diameter covering each metallic conductor can be in a range of about 0.0310 inches to about 0.0360 inches, for example. As will be discussed in further detail below, the insulation 101 (1011, 1012, 1013, 1014) covering the electrical conductors of the twisted pairs 105 can comprise a combination of economical materials configured to achieve electrical and fire performance objectives.

In certain exemplary embodiments, at least two of the twisted pairs 1051, 1052, 1053, 1054 have different twist rates (twists-per-meter or twists-per-foot). That is, at least two of the twisted pairs 1051, 1052, 1053, 1054 have different twist lengths or twist lays, which can be characterized in units of centimeters-per-twist, inches-per-twist, or inches-per-lay. In certain exemplary embodiments, each of the twisted pairs 1051, 1052, 1053, 1054 has a different twist length.

In the illustrated view, each twisted pair 1051, 1052, 1053, 1054 sweeps out a respective twist path 115 as it twists/rotates, with the twist paths 115 generally circular when viewed end-on as illustrated. (The twist paths 115 are illustrated in approximation.)

In certain exemplary embodiments, the differences between twist rates of twisted pairs 105 that are circumferentially adjacent one another (for example the twisted pair 1051 and the twisted pair 1052) are greater than the differences between twist rates of twisted pairs 105 that are diagonal from one another (for example the twisted pair 1051 and the twisted pair 1053). The different twist lengths can help reduce crosstalk among the twisted pairs 105.

The cable core 125 can be filled with a gas such as air (as illustrated) or alternatively a gelatinous, solid, powder, moisture absorbing material, water-swellable substance, dry filling compound, or foam material, for example in interstitial space between the twisted pairs 105. Other elements can be added to the cable core 125, for example one or more optical fibers, additional electrical conductors, additional twisted pairs, or strength members, depending upon application goals.

In certain embodiments, the communication cable 100 can comprise a flexible member (not illustrated) that maintains a desired orientation of the twisted pairs 105 to provide beneficial signal performance. In an exemplary embodiment, the flexible member can be a pair separator. In certain embodiments, the flexible member can have a cross sectional geometry resembling a plus sign. Various embodiments may be shaped like an “X,” a “T,” a “Y,” a “J,” a “K”, an “L” an “I,” or have a form of a flat strip, or a circular cross section, or comprise two or three or more fins, for example.

In various exemplary embodiments, the flexible member can comprise polyvinyl chloride (typically but not necessarily low-smoke polyvinyl chloride), polypropylene, polyethylene, fluorinated ethylene propylene, ethylene chlorotrifluoroethlyene (“ECTFE”), or some other suitable polymeric or dielectric material, for example. In various exemplary embodiments, the flexible member can consist of, or substantially consist of, polyvinyl chloride, polypropylene, polyethylene, fluorinated ethylene propylene, ethylene chlorotrifluoroethlyene, or some other suitable polymeric or dielectric material, for example. The flexible member can be filled, unfilled, foamed, un-foamed, homogeneous, or inhomogeneous and may or may not comprise additives. The flexible member can comprise flame retardant and/or smoke suppressant materials. The flexible member can be extruded, pultruded, or formed in another appropriate process known in the art.

The flexible member can have a substantially uniform composition, can be made of a wide range of materials, and/or can be fabricated in a single manufacturing pass. Further, the flexible member can be a composite and can include one or more strength members, fibers, optical fibers, metallic conductors, cavities, threads, or yarns. Additionally, the flexible member can be hollow to provide a cavity that may be filled with air or some other gas, gel, fluid, moisture absorbent, water-swellable substance, dry filling compound, powder, an optical fiber, a metallic conductor, shielding, or some other appropriate material or element.

In certain exemplary embodiments, the flexible member can comprise electrically conductive patches that are electrically isolated from one another to provide one or more shields. Such patches can adhere to a surface of the flexible member, for example.

In certain exemplary embodiments, the flexible member can comprise polyvinyl chloride, be based on polyvinyl chloride, or have a composition that is at least 70 percent, 80 percent, 90 percent, 95 percent, 99 percent polyvinyl chloride or in a range between any two of these values. (In certain embodiments, such percentages are on a volume basis. In certain embodiments, such percentages are on a weight basis.)

In certain embodiments, the flexible member and the jacket 120 can comprise common polymeric materials, for example both being based on polyvinyl chloride. Accordingly, the flexible member can have a substantial content of polyvinyl chloride or another economical polymeric material.

Turning now to FIG. 2, this figure illustrates a twisted pair 105 (1051, 1052, 1053, 1054) of the communication cable 100 according to certain exemplary embodiments of the present invention. The twisted illustrated twisted pair 105 has a twist length 200 (which may also be characterized as twist lay or twin lay). For example, if the insulated electrical conductors 201 and 202 of the illustrated pair 105 (1051, 1052, 1053, 1054) are twisted together so as to revolve around one another two times-per-inch, the twist rate would be two twists-per-inch, and the twist length or lay length would be one-half inch. In certain exemplary embodiments, each of the twisted pairs 1051, 1052, 1053, 1054 of the communication cable 100 has a different twist length 200. In certain exemplary embodiments, the twist lengths 200 of the twisted pairs 105 (1051, 1052, 1053, 1054) can be in a range of about 0.250 to 0.900 inches, 0.350 to 0.850 inches, 0.400 to 0.475 inches, or 0.480 inches to 0.812 inches for example.

In various exemplary embodiments, the twisted pairs 105 can have a common twist direction that is clockwise or counterclockwise. In certain embodiments, at least one of the twisted pairs 1051, 1052, 1053, 1054 can be twisted in a clockwise direction, while other ones are twisted counterclockwise. Accordingly, the twisted pairs 105 may have a “left hand lay” or a “right hand lay” or a combination thereof

In certain embodiments, material compositions and electrical performances of the insulation 101 (1011, 1012, 1013, 1014) of the twisted pairs 105 (1051, 1052, 1053, 1054) can be selected according to twist length 200. In certain embodiments, economical insulation can be incorporated on twisted pairs 105 (1051, 1052, 1053, 1054) having longer twist length 200 and less stringent electrical demands. Thus, pairs that are twisted less tightly, and thus less susceptible to interaction with other cable elements, can be insulated with materials having relaxed electrical performance relative to premium insulation. For example, two twisted pairs 105 (1051, 1052, 1053, 1054) having the longer twist lengths 200 can have economical insulation comprising polyethylene skinned with polyvinyl chloride, while two other twisted pairs 105 (1051, 1052, 1053, 1054) having the shorter twist lengths 200 can have premium insulation comprising fluorinated ethylene propylene. Accordingly, economical and premium insulations can be utilized together.

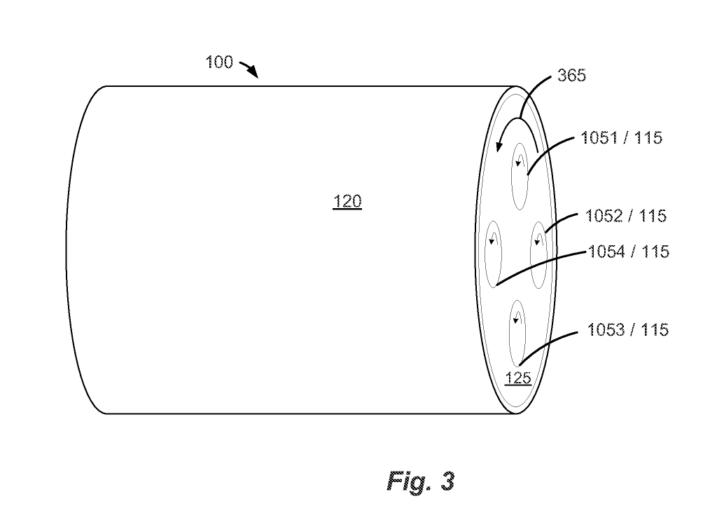

Turning now to FIG. 3, this figure illustrates twists of the communication cable 100 according to certain exemplary embodiments of the present invention. In the illustrated embodiment of FIG. 3, the core 125 has a twist 365 in a direction that is common to the pair twist. Thus, the core 125 and the twisted pairs 1051, 1052, 1053, 1054 can each have left hand lay or twist in counterclockwise direction as illustrated. Alternatively, the core 125 and the twisted pairs 1051, 1052, 1053, 1054 can each have right hand lay or twist in clockwise direction. Accordingly, the four twisted pairs 1051, 1052, 1053, 1054 can be collectively twisted about a longitudinal axis 135 (see FIG. 1) of the communication cable 100 in a common direction.

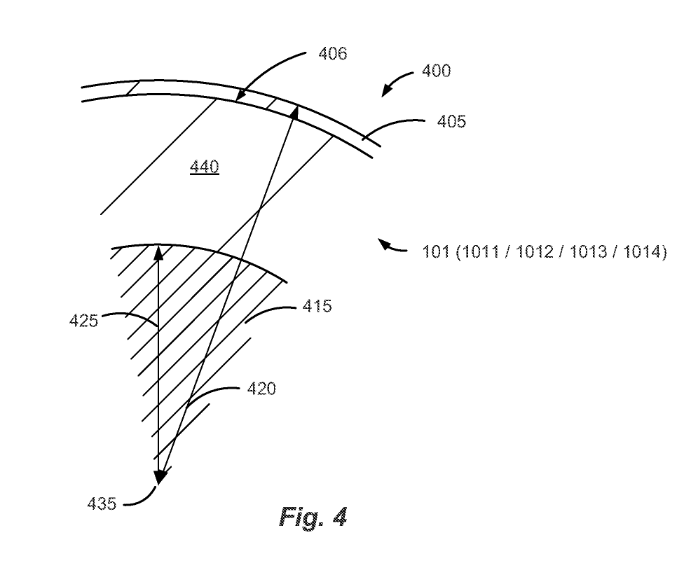

Turning now to FIG. 4, this figure illustrates insulation 101 (1011, 1012, 1013, 1014) covering an electrical conductor 415 of a twisted pair 105 (1051, 1052, 1053, 1054) according to in certain exemplary embodiments of the present invention.

In the illustrated embodiment, the insulation 101 (1011, 1012, 1013, 1014) of the insulated electrical conductor 400 comprises a skin 405 covering an inner region 440. The skin 405 can comprise a polymer with improved fire characteristics as compared to the inner region 440. Accordingly, the material of the skin 405 burns less readily or intensely and/or generates less smoke than the material of the inner region 440. In one exemplary embodiment, the skin 405 comprises low smoke polyvinyl chloride and the inner region 440 comprises foamed polyethylene, solid polyethylene, or another appropriate foamed or solid polyolefin.

The skin 405 can comprise a polymer with lower electrical performance than the polymer of the inner region 440. In certain exemplary embodiments, the skin 405 can comprise a polymer having a higher dielectric constant than the dielectric constant of the polymer of the inner region 440. In certain exemplary embodiments, the skin 405 can comprise a polymer having a higher dissipation factor than the dissipation factor of the polymer of the inner region 440 at an operating frequency of the communication cable 100. As discussed above, the skin 405 can comprise polyvinyl chloride while the inner region 440 comprises foamed or solid polyethylene.

In certain embodiments polyvinyl chloride of the skin 405 is chemically bonded to polyethylene of the inner region 440, for example at the material interface 406. Such chemical bonding can result from adding an agent or additive, such as ethylene vinyl acetate, at the material interface 406 or in one or both of the inner region 440 and the skin 405 to promote or cause chemical bonding between two polymers not otherwise receptive to bonding.

In certain exemplary embodiments, the electrical conductors 415 of the communication cable 100 can have consistent or common diameters (twice the illustrated radius 425 that extends from the center axis 435 radially outward), for example being manufactured to a common specification. Alternatively, in certain exemplary embodiments, the electrical conductors 415 of different twisted pairs 105 can have different diameters. In certain exemplary embodiments, the electrical conductors 415 can be 22, 23, or 24 AWG (American Wire Gauge). In certain exemplary embodiments, the electrical conductors 415 can have a diameter in a range of about 0.0201 to 0.0253 inches, for example. In certain exemplary embodiments, the electrical conductors 415 can have a diameter in a range of about 0.0195 to 0.0198 inches, for example.

In certain exemplary embodiments, the insulated electrical conductors 400 of each twisted pair 1051, 1052, 1053, 1054 within the communication cable 100 can have an outer diameter (twice the illustrated radius 420) that is consistent or common. Alternatively, in certain exemplary embodiments, the insulated electrical conductors 400 of the communication cable 100 can have different insulation thicknesses. In certain exemplary embodiments, the thickness of the insulation 101 (1011, 1012, 1013, 1014) can be in a range of about 0.005 to 0.015 inches, for example.

As discussed above, in certain embodiments, the insulations 101 (1011, 1012, 1013, 1014) of the twisted pairs 105 (1051, 1052, 1053, 1054) can share a common architecture and composition. Thus, all of the insulations 101 (1011, 1012, 1013, 1014) can comprise a skin 405 functioning as a fire barrier and an inner region 440 that provides desirable electrical performance in accordance with FIG. 4. Alternatively, a subset of the insulations 101 (1011, 1012, 1013, 1014) of the twisted pairs 105 (1051, 1052, 1053, 1054) can utilize a premium insulation such as fluorinated ethylene propylene. Other insulations 101 (1011, 1012, 1013, 1014) of the twisted pairs 105 (1051, 1052, 1053, 1054) can comprise a skin 405 functioning as a fire barrier covering the inner region 440 that provides desirable electrical properties.

In certain embodiments, one twisted pair 105 can comprise one electrical conductor 415 that is insulated with a fluoropolymer such as fluorinated ethylene propylene and another electrical conductor 415 that is insulated with an inner region 400 of foamed polyethylene covered with a skin of polyvinyl chloride.

Referring now to FIGS. 1, 2, and 4, one exemplary embodiment will be described in further detail. In this embodiment, the jacket 120 comprises low smoke plenum polyvinyl chloride material. The resulting jacket has a nominal wall thickness of approximately 0.020 inches and an inner diameter of approximately 0.152 inches.

The twisted pair 1051 of this embodiment has an insulation 1011 that is colored blue and is made of fluorinated ethylene propylene. The insulation 1011 has an outer diameter of approximately 0.0320 inches, covering an electrical conductor 415 having a diameter of approximately 0.0196 inches.

The twisted pair 1052 of this embodiment has an insulation 1012 that is colored orange and comprises an inner region 440 of foamed high density polyethylene. The inner region 440 is covered with a skin 405 of low smoke polyvinyl. The skin 405 has a thickness of approximately 0.0020 inches. The insulation 1012 has an outer diameter of approximately 0.0350 inches, covering an electrical conductor 415 having a diameter of approximately 0.0197 inches.

The twisted pair 1053 of this embodiment has an insulation 1013 that is colored green and comprises fluorinated ethylene propylene. The insulation 1013 has an outer diameter of approximately 0.0320 inches, covering an electrical conductor 415 having a diameter of approximately 0.0196 inches.

The twisted pair 1054 of this embodiment has an insulation 1014 that is colored brown and is made of an inner region 440 of foamed high density. The inner region 440 is covered with a skin 405 of low smoke polyvinyl chloride. The skin 405 has a thickness of approximately 0.0020 inches. The insulation 1014 has an outer diameter of approximately 0.0350 inches, covering an electrical conductor 415 having a diameter of approximately 0.0197 inches.

From the foregoing, it will be appreciated that an embodiment of the present invention overcomes the limitations of the prior art. Those skilled in the art will appreciate that the present invention is not limited to any specifically discussed application and that the embodiments described herein are illustrative and not restrictive. From the description of the exemplary embodiments, equivalents of the elements shown herein will suggest themselves to those skilled in the art, and ways of constructing other embodiments of the present invention will suggest themselves to practitioners of the art. Therefore, the scope of the present invention is to be limited only by the claims that follow.

What is claimed is:

1. A communications plenum cable comprising:
a first pair of electrical conductors extending lengthwise, twisted to a first twist length, and individually insulated with fluorinated ethylene propylene;
a second pair of electrical conductors extending lengthwise, twisted to a second twist length, and individually insulated with foamed polyethylene covered with a polyvinyl chloride skin;
a third pair of electrical conductors extending lengthwise, twisted to a third twist length, and individually insulated;
a fourth pair of electrical conductors extending lengthwise, twisted to a fourth twist length, and individually insulated; and
an outer jacket extending lengthwise, circumferentially covering the pairs and the flexible member, and comprising polyvinyl chloride,
wherein the first twist length, the second twist length, third twist length, and the fourth twist length are different.

2. The communications plenum cable of claim 1, wherein the third pair of electrical conductors is individually insulated with foamed polyethylene covered with a polyvinyl chloride skin.

3. The communications plenum cable of claim 2, wherein the fourth pair of electrical conductors is individually insulated with fluorinated ethylene propylene.

4. The communications plenum cable of claim 3, wherein the polyvinyl chloride skin of the second pair comprises low smoke polyvinyl chloride,
wherein the polyvinyl chloride skin of the third pair comprises low smoke polyvinyl chloride, and
wherein the polyvinyl chloride of the jacket comprises low smoke polyvinyl chloride.

5. The communications plenum cable of claim 1, wherein an agent that is disposed at an interface between the foamed polyethylene and the polyvinyl chloride bonds the foamed polyethylene to the polyvinyl chloride.

6. The communications plenum cable of claim 1, wherein an agent that is disposed in the foamed polyethylene and the polyvinyl chloride bonds the foamed polyethylene to the polyvinyl chloride.

7. The communications plenum cable of claim 1, wherein an agent that is disposed in the polyvinyl chloride bonds the foamed polyethylene to the polyvinyl chloride.

8. A communication cable comprising:
a jacket defining an interior space that extends lengthwise about a longitudinal axis of the communication cable;
a first plurality of electrical signal conductors that are disposed in the interior space and individually covered with first insulation comprising fluorine, wherein the first plurality of electrical signal conductors are twisted together; and
a second plurality of electrical signal conductors that are disposed in the interior space and that are individually covered with second insulation comprising polyethylene covered with polyvinyl chloride, wherein the second plurality of electrical signal conductors are twisted together.

9. The communication cable of claim 8, further comprising:
a third plurality of electrical signal conductors that are disposed in the interior space and individually covered with the first insulation; and
a fourth plurality of electrical signal conductors that are disposed in the interior space and individually covered with the second insulation,
wherein the jacket comprises polyvinyl chloride, and
wherein the first insulation comprises fluorinated ethylene propylene.

10. The communication cable of claim 8, wherein the polyethylene comprises foamed polyethylene, and
wherein the polyvinyl chloride forms a skin over the foamed polyethylene.

11. The communication cable of claim 8, wherein the communication cable is rated as a category 5, category 5E, category 6, or category 6 enhanced communication plenum cable.

12. The communication cable of claim 8, wherein the communication cable is qualified for deployment in air-handling spaces.

13. The communication cable of claim 8, wherein the polyethylene and the polyvinyl chloride are chemically bonded to one another, and
wherein the first insulation comprises fluorinated ethylene propylene.

14. A communication cable comprising:
a first twisted pair comprising:
a first signal conductor comprising a first metal wire covered with first insulation; and
a second signal conductor comprising a second metal wire covered with second insulation,
wherein the first insulation comprises a first polymer that is covered with a fire barrier, the fire barrier partially disposed between the first metal wire and the second metal wire;
a second twisted pair comprising:
a third signal conductor comprising a third metal wire covered with third insulation; and
a fourth signal conductor comprising a fourth metal wire covered with fourth insulation,
wherein the third insulation has a better fire rating than the first polymer; and
a jacket covering the first twisted pair and the second twisted pair,

15. The communication cable of claim 14, wherein the first polymer is foamed.

16. The communication cable of claim 14, wherein the first polymer comprises polyethylene, and
wherein the fire barrier comprises a polyvinyl chloride skin.

17. The communication cable of claim 14, wherein the third insulation and the fourth insulation each comprises fluorinated ethylene propylene.

18. The communication cable of claim 14, wherein the first insulation and the second insulation have common compositions, and
wherein the fourth insulation comprises fluorine.

19. The communication cable of claim 14, wherein the polyethylene and the polyvinyl chloride are chemically bonded to one another.

20. The communication cable of claim 14, wherein the communication cable is a category 5, category 5E, category 6, or category 6 enhanced communication plenum cable.

21. The communication cable of claim 14, wherein the jacket comprises low smoke polyvinyl chloride,
wherein the first polymer comprises foamed polyethylene,
wherein the fire barrier comprises low smoke polyvinyl chloride circumscribing the first polymer,
wherein the second insulation comprises foamed polyethylene covered with a second fire barrier that comprises low smoke polyvinyl chloride,
wherein the third insulation comprises fluorinated ethylene propylene,
wherein the fourth insulation comprises fluorinated ethylene propylene, and
wherein the communication cable further comprises:
a third twisted pair; and
a fourth twisted pair.

22. The communication cable of claim 14, wherein an additive binds the low smoke polyvinyl chloride of the fire barrier to the foamed polyethylene of the first polymer,
wherein the first twisted pair, the second twisted pair, the third twisted pair, and the fourth twisted pair are twisted to different twist lengths,
wherein the communication cable is a communication plenum cable,
wherein the first metal wire, the second metal wire, the third metal wire, and the fourth metal wire each comprises copper,
wherein the third twisted pair and the first twisted pair have common insulation materials, and
wherein the second twisted pair and the fourth twisted pair have common insulation materials.

23. The communication cable of claim 14, wherein the communications cable is plenum rated,
wherein the first polymer comprises polyolefin,
wherein the second polymer comprises chlorine, and
wherein the third insulation comprises fluorine.

24. A communications plenum cable comprising:
a plurality of pairs of electrical conductors extending lengthwise, wherein at least one pair is insulated with polyethylene covered with polyvinyl chloride skin and at least one other pair is insulated with fluorinated ethylene propylene; and
an outer jacket extending lengthwise, circumferentially covering the pairs, and comprising polyvinyl chloride.

25. The communications plenum cable of claim 24, wherein the polyethylene comprises solid polyethylene.

26. The communications plenum cable of claim 24, wherein the polyethylene comprises foamed polyethylene.

27. The communication cable of claim 24, wherein the communication cable is a category 5, category 5E, category 6, or category 6 enhanced communication plenum cable.

28. The communication cable of claim 24, wherein the polyethylene and the polyvinyl chloride are chemically bonded to one another.
